(19) United States
(12) Patent Application Publication
(10) Pub. No.: US 2005/0259430 A1
(43) Pub. Date: Nov. 24, 2005

(54) Collapsible automobile rear view mirror

(76) Inventor: Wen Huang, Tainan (TW)

Correspondence Address: Wen HUANG, No. 25, Alley 244, Lane 484, Sec. 1, Chin Hua Road, Tainan, 700, TW

(21) Appl. No.: 10/851,968

(22) Filed: May 24, 2004

(51) Int. Cl. B60R 1/12

(52) U.S. Cl. 362/494

(57) ABSTRACT

A collapsible automobile rear view mirror has auxiliary directional lights installed in a fundamental base having its topside pivotally combined with a rear view mirror shell, or in the combining end of the rear view mirror shell, the auxiliary directional lights able to function synchronously with the directional lights of an automobile. The flash of the auxiliary directional lights can be transmitted outward through the light transmitting holes bored in the front and the rear side of the fundamental base or the combining end of the rear view mirror shell to be seen by the drivers of other automobiles coming from front and from behind.

### BACKGROUND OF THE INVENTION

1. Field of the Invention

This invention relates to a collapsible automobile rear view mirror, particularly to one having auxiliary directional lights installed in a fundamental base, which is pivotally combined with the shell of a rear view mirror or in the combining end of the mirror shell to function synchronously with the directional lights of an automobile. Thus, the flash of the auxiliary directional lights can be transmitted outward through the light transmitting holes of the front and the rear side of the fundamental base or through the light transmitting holes of the combining end of the mirror shell to be seen by the drivers of other automobiles coming from front and from behind.

2. Description of the Prior Art

Conventionally, an automobile usually has auxiliary directional lights installed at the backside of a rear view mirror shell to face the front of the automobile; therefore, the flash of the auxiliary directional lights only can be seen by the drivers of other automobiles coming from front. To improve such a defect, some automobiles have auxiliary directional lights installed at a certain location of the glass surface of the rear view mirror so that the flash of the auxiliary directional lights can be seen by the drivers of other automobiles coming from behind, but in this case, the area of the mirror surface will be diminished to influence a driver's visual field, and the flash of the auxiliary directional lights will also influence the original function of the rear view mirror.

### SUMMARY OF THE INVENTION

The objective of the invention is to offer a collapsible automobile rear view mirror having auxiliary directional lights installed in a fundamental base pivotally combined with the shell of a rear view mirror or in the combining end of the mirror shell to let the flash of the auxiliary directional lights seen by the drivers of other automobiles coming from front and from behind, impossible to affect the original function of the rear view mirror.

The feature of the invention is to have auxiliary directional lights installed in the fundamental base pivotally combined under the shell of the rear view mirror or in the pivotal combining end of the mirror shell so that the flash of the auxiliary directional lights can be transmitted outward through the light transmitting holes of the front and the rear side of the fundament base or the combining end of the mirror shell to be seen by the drivers of other automobiles coming from front and from behind.

### BRIEF DESCRIPTION OF DRAWINGS

This invention will be better understood by referring to the accompanying drawings, wherein:

FIG. 1 is an exploded perspective view of a first preferred embodiment of a collapsible automobile rear view mirror in the present invention:

FIG. 2 is an upper view of the fundamental base of the collapsible automobile rear view mirror in the first preferred embodiment in the present invention:

FIG. 3 is an exploded perspective view of a second preferred embodiment of the collapsible automobile rear view mirror in the present invention:

FIG. 4 is an upper view of the fundamental base of the collapsible automobile rear view mirror in the second preferred embodiment in the present invention: and

FIG. 5 is an exploded perspective view of a third preferred embodiment of the collapsible automobile rear view mirror in the present invention.

### DETAILED DESCRIPTION OF THE PREFERRED EMBODIMENT

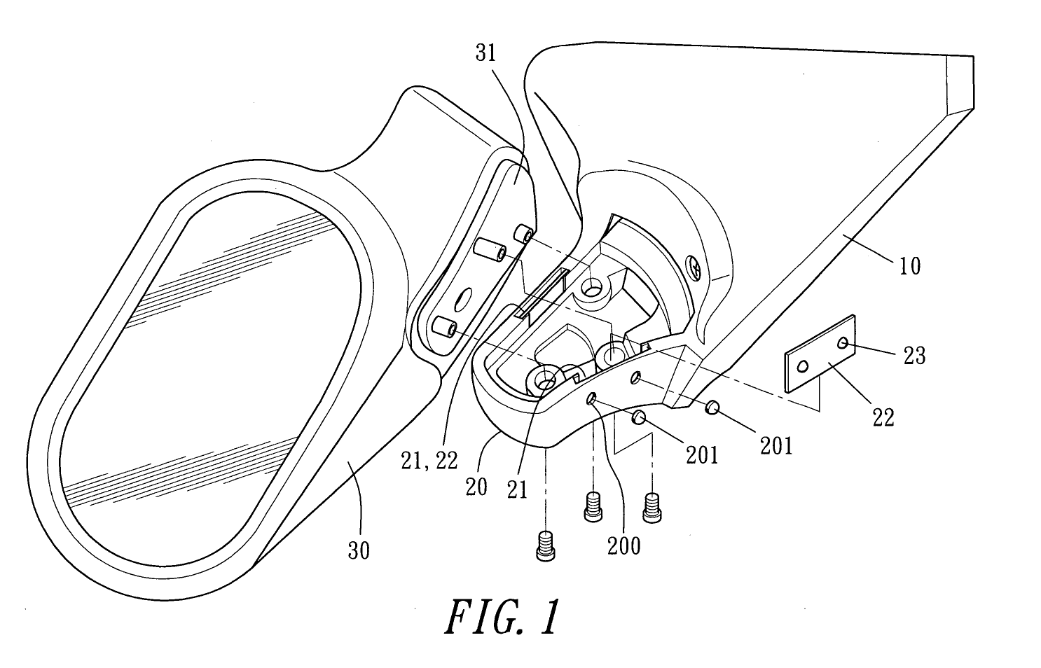

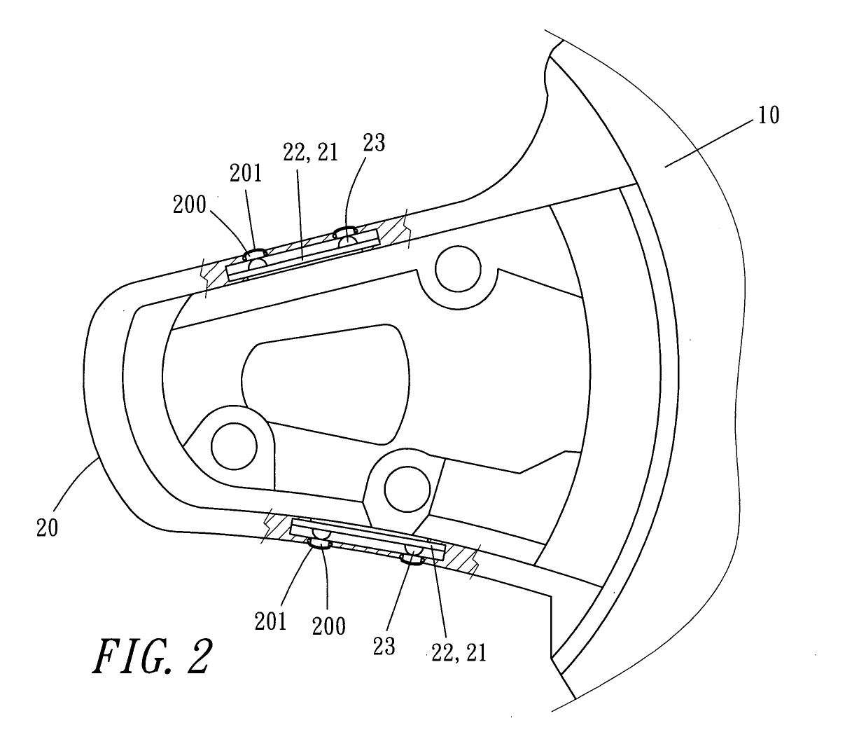

A first preferred embodiment of a collapsible automobile rear view mirror in the present invention, as shown in FIGS. 1 and 2, includes a fixing base 10, a fundamental base 20 and a rear view mirror body 30 combined together.

The fixing base 10 is fixed on an automobile body, having its lower end extending outward and forming the fundamental base 20.

The fundamental base 20 has its front and rear inner wall respectively bored with an insert groove 21 spaced apart oppositely for the electron board 22 of auxiliary directional lights to be inserted therein. The fundamental base 20 further has its front and rear side respectively provided with light transmitting holes 200 and light transmitting shades 201 at the locations facing the auxiliary directional lights 23 on the electron board 22. Thus, when the auxiliary directional lights 23 function synchronously with the directional lights of an automobile, their light rays are able to pass through the light transmitting holes 200 and the light transmitting shades 201 at the front and the rear side of the fundamental base 20 and their flash can be seen by the drivers of other automobiles coming from front and from behind.

The rear view mirror body 30 has one end pivotally combined with the fundamental base 20 by means of a pivotal member 31, able to be pulled outward for use or collapsed by pulled inward after parking.

After the fixing base 10, the fundamental base 20 and the rear view mirror body 30 are combined together, the flash of the auxiliary directional lights can be seen through the light transmitting holes 200 of the front and the rear side of the fundamental base 20, impossible to affect the original function of the rear view mirror.

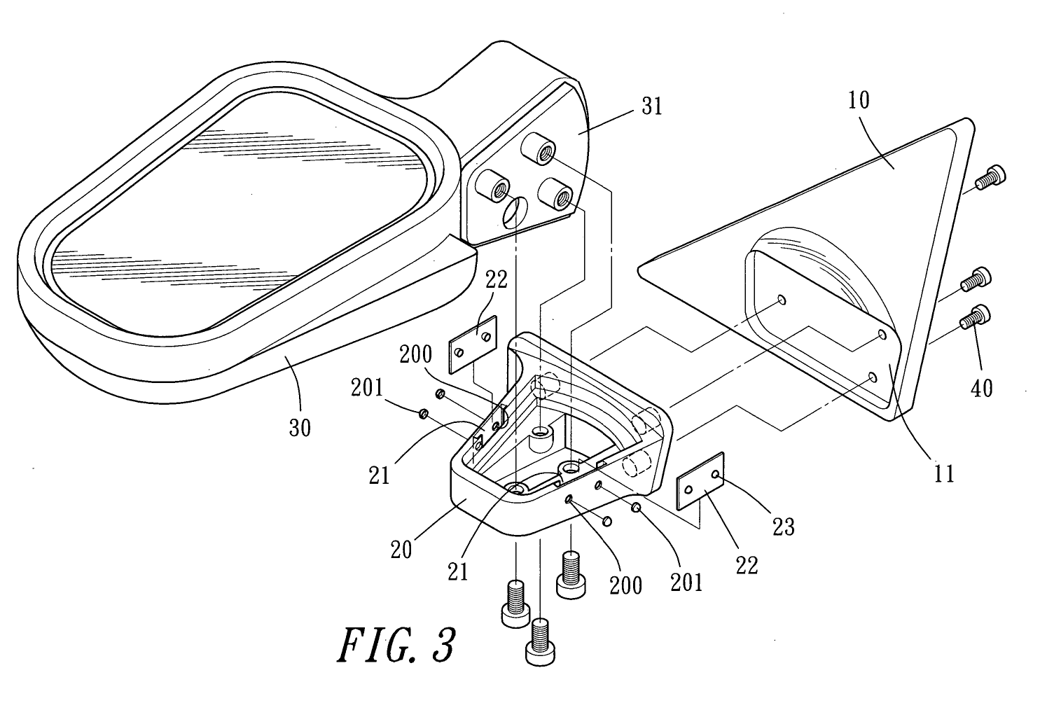

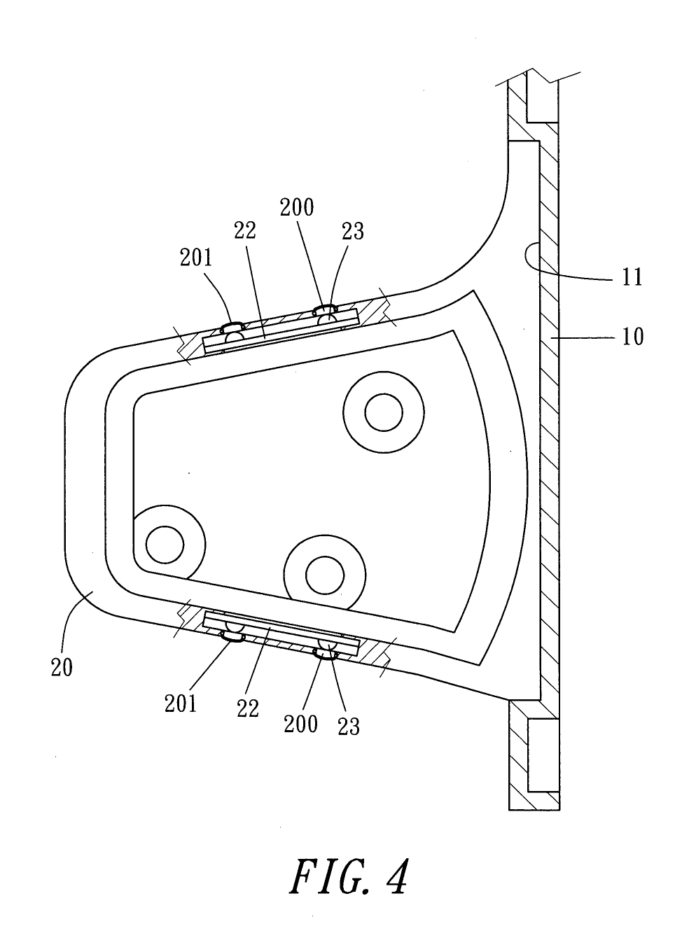

A second preferred embodiment of a collapsible automobile rear view mirror in the present invention, as shown in FIGS. 3 and 4 has a different structure that the fixing base 10 is combined with the fundamental base 20 by means of fitting and fixed by screws, including the fixing base 10 having its outer side bored with a recessed groove 11 for the combining end of the fundamental base 20 to be engaged therein, and then the fixing base 10 and the fundamental base 30 are firmly combined together by bolts 40. The fundamental base 20 has its front and rear inner wall respectively bored with an insert groove 21 inserted therein with an electron board 20, auxiliary directional lights 23 and light transmitting holes 200 as well as light transmitting shades 201.

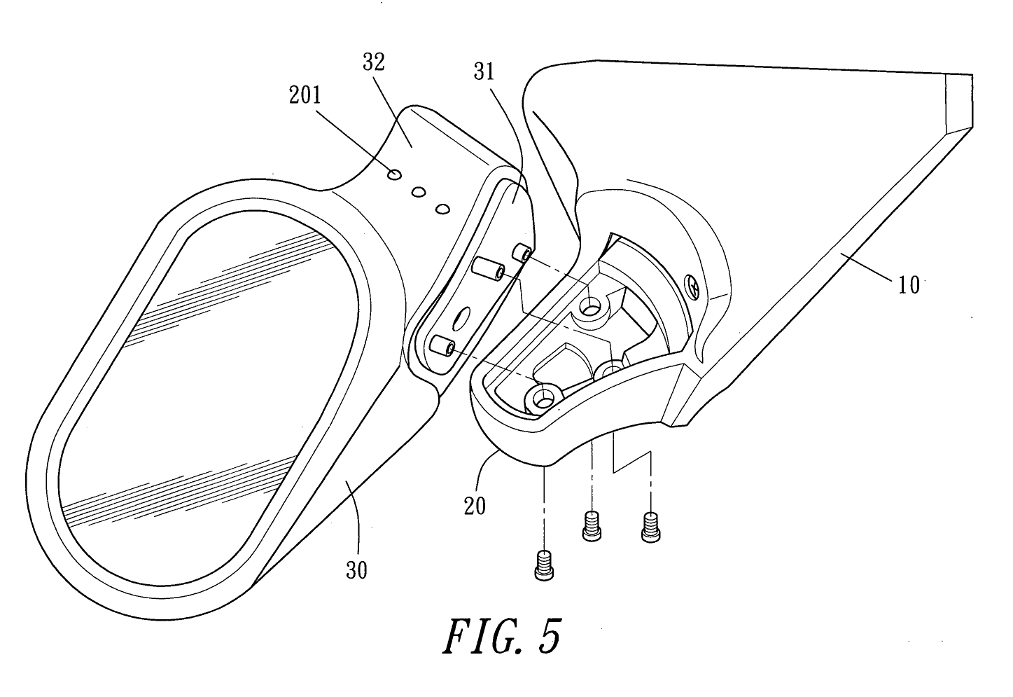

A third preferred embodiment of a collapsible automobile rear view mirror in the present invention, as shown in FIG. 5, is to have auxiliary directional lights 23 in the combining end 32 of a mirror shell. The combining end 32 of the mirror shell has its front and rear side respectively provided with light transmitting holes 200 and light transmitting shades 201 so as to let the flash of the auxiliary directional lights seen by the drivers of other automobiles coming from front and from behind, impossible to affect the original function of the rear view mirror.

Specifically, the collapsible automobile rear view mirror in the present invention has the auxiliary directional lights 23 and the electron boards 22 installed in the fundamental base 20 or in the combining end 32 of the rear view mirror shell to function synchronously with the directional lights of an automobile, and the functional base 20 or the combining end 32 of the mirror shell has its front and rear side respectively provided with light transmitting holes and light transmitting shades. Therefore, the flash of the auxiliary directional lights can be transmitted outward through the light transmitting holes 200 to be seen by the drivers of other automobiles coming from front and from behind, and it is impossible to affect the original function of the rear view mirror.

While the preferred embodiments of the invention have been described above, it will be recognized and understood that various modifications may be made therein and the appended claims are intended to cover all such modifications that may fall within the spirit and scope of the invention.

1. A collapsible automobile rear view mirror comprising a fixing base, said fixing base having one end extending outward and forming a fundamental base, said fundamental base having its topside pivotally combined with the shell of a rear view mirror: and,
Characterized by auxiliary directional lights installed in said fundamental base, said auxiliary directional lights able to function synchronously with the directional lights of an automobile, the flash of said auxiliary directional lights transmitted outward through the front and the rear side of said fundamental base, said flash-of said auxiliary-directional lights able to be seen by the drivers of other automobiles coming from front and from behind.

2. The collapsible automobile rear view mirror as claimed in claim 1, wherein said fundamental base has its front and rear inner wall respectively bored with an insert groove for the electron boards of said auxiliary directional lights to be inserted and fixed therein, and its front and rear side respectively provided with light transmitting holes at the locations facing said auxiliary directional lights, each said light transmitting hole covered with a light transmitting shade, the flash of said auxiliary directional lights able to be transmitted outward through said light transmitting holes and said light transmitting shades.

3. A collapsible automobile rear view mirror comprising a fixing base, said fixing base having one end extending outward and forming a fundamental base, said fundament base having its topside pivotally combined with the combining end of a rear view mirror shell: and,
Characterized by auxiliary directional lights installed in said combining end of said rear view mirror shell, said auxiliary directional lights able to function synchronously with the directional lights of an automobile, the light rays of said auxiliary directional lights able to be transmitted outward through the front and the rear side of said combining end of said rear view mirror shell, the flash of said auxiliary directional lights able to be seen by the drivers of other automobile coming from front and from behind.

4. The collapsible automobile rear view mirror as claimed in claim 1, wherein said combining end of said rear view mirror shell has its front and rear inner wall respectively bored with an insert groove for the electron board of said auxiliary directional lights to be inserted and fixed therein, and also has its front and rear side respectively provided with light transmitting holes at the locations facing said auxiliary directional lights and each said light transmitting hole is covered with a light transmitting shade, letting the light rays of said auxiliary directional lights transmitted outward through said light transmitting holes and shades.
